(19) United States
(12) Patent Application Publication
(10) Pub. No.: US 2014/0049951 A1
(43) Pub. Date: Feb. 20, 2014

(54) CONDENSING LENS AND LIGHTING DEVICE INCLUDING THE SAME

(71) Applicant: SAMSUNG ELECTRONICS CO., LTD., Suwon-si (KR)

(72) Inventor: Tetsuo ARIYOSHI, Suwon-si (KR)

(73) Assignee: SAMSUNG ELECTRONICS CO., LTD., Suwon-si (KR)

(21) Appl. No.: 13/965,943

(22) Filed: Aug. 13, 2013

(30) Foreign Application Priority Data
Aug. 14, 2012 (KR) 10-2012-0088755

(51) Int. Cl. F21V 13/04; F21L 4/00; F21L 4/02; F21V 19/00

(52) U.S. Cl. CPC F21V 13/04; F21V 19/00; F21L 4/00; F21L 4/02
USPC 362/184; 362/308; 362/208

(57) ABSTRACT

A condensing lens includes a main body. The main body includes a light emitting diode (LED) receiving portion defined in a ring shape and depressed at one side of the main body to receive an LED in a circumferential direction. The main body also includes a light incidence surface to which light emitted from the LED is incident, a light emission surface defined at another side of the main body and configured to emit the incident light, and a reflective surface to reflect the incident light.

### CROSS-REFERENCE TO RELATED APPLICATION

This application claims benefit of priority to Korean Patent Application No. 10-2012-0088755, filed on Aug. 14, 2012, in the Korean Intellectual Property Office, the entire contents of which are hereby incorporated by reference.

### TECHNICAL FIELD

The present inventive concept relates to a condensing lens and a lighting device including the condensing lens.

### BACKGROUND

A light emitting diode (LED) refers to a semiconductor device that emits light when an electric current flows. That is, the LED refers to a p-n junction diode including gallium arsenide (GaAs), Ga nitride (GaN) optical semiconductors, as an electronic part that converts electrical energy to optical energy.

Recently, a blue LED and an ultraviolet (UV) LED that use nitrides having excellent physical and chemical characteristics have been introduced. Since the blue LED or UV LED may implement white light or other monochromatic lights using a phosphor material, application fields of the LED are expanding.

The LED has a relatively long life, and may be implemented in a small size and with a low weight. Also, since the LED has strong directivity of light emission, low-voltage driving is possible. In addition, the LED is durable against impact and vibration and does not require preheating and complicated driving, and therefore is applied to various uses. For example, in recent days, the application fields of the LED are expanding from small lighting for a mobile terminal to general interior and exterior lighting, vehicle lighting, a backlight unit (BLU) for a large-area liquid crystal display (LCD), and the like.

However, generally, an emission angle of the LED is about 120°, that is, extremely large, and the intensity of light emitted out of an optic axis is so small compared to the intensity of light emitted from a center of the optic axis. Therefore, to use the LED for lighting, the emitted light needs to be concentrated to a local region and the intensity of the emitted light needs to be controlled.

For this, accordingly, there is a desire for a condensing lens that condenses light emitted from an LED by a predetermined angle, thereby achieving high light distribution characteristic. Relevant researches are being actively conducted.

### SUMMARY

An aspect of the present inventive concept relates to a condensing lens including a main body. The main body includes a light emitting diode (LED) receiving portion defined in a ring shape and depressed at one side of the main body to receive an LED in a circumferential direction. The main body includes a light incidence surface to which light emitted from the LED is incident, a light emission surface defined at another side of the main body and configured to emit the incident light, and a reflective surface to reflect the incident light.

The LED receiving portion may be configured to receive a plurality of LEDs.

The reflective surface may be configured to perform total reflection.

The condensing lens may further include a plurality of prisms arranged in a circumferential direction on the light emission surface.

The plurality of prisms may be arranged continuously without intervals.

The LED receiving portion may be configured to receive a plurality of LEDs, and a length of a lower surface of each of the plurality of prisms may be smaller than an interval between the plurality of LEDs when the plurality of LEDs are received in the LED receiving portion.

Another aspect of the present inventive concept encompasses a lighting device including a substrate, a light emitting diode (LED) disposed on the substrate, the condensing lens configured to condense light emitted from the LED, a heat sink to receive and support the substrate and to emit heat generated from the LED to an outside, and a power device to provide power to the LED. The condensing lens includes a main body including a light emitting diode (LED) receiving portion defined in a ring shape and depressed at one side of the main body to receive the LED in a circumferential direction. The main body includes a light incidence surface to which light emitted from the LED is incident, a light emission surface defined at another side of the main body and configured to emit the incident light, and a reflective surface to reflect the incident light.

The LED may be a plurality of LEDs.

The LED may be a linear LED or a flat LED in a ring shape corresponding to the ring shape of the LED receiving portion.

A thermal interface material may be applied between a surface of the substrate and the heat sink to minimize thermal resistance.

The heat sink may include a plurality of heat radiation fins or heat radiation plates radially arranged along a circumference.

Still another aspect of the present inventive concept relates to condensing lens including a main body. The main body includes a light emitting diode (LED) receiving portion defined in a ring shape and depressed at one side of the main body to receive an LED in a circumferential direction. The main body has a reflective surface defined at an inner surface and an outer surface of the main body such that light emitted from the LED is reflected and condensed in a radial direction when the LED is received in the LED receiving portion.

The main body may include a light incidence surface to which the light emitted from the LED is incident and a light emission surface defined at another side of the main body and configured to emit the incident light. The reflective surface may be configured to reflect the incident light.

The reflective surface may include surfaces inclined in radial directions.

The reflective surface may include a first surface disposed on the inner surface and a second surface disposed on the outer surface of the main body, the first and second surfaces being symmetrically disposed.

The LED receiving portion may have a rectangular cross section.

The light emission surface may be defined by a plurality of prisms, each of which extends concentrically to the center of the light emission surface.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept. In the drawings, the thickness of layers and regions may be exaggerated for clarity.

FIGS. 1A and 1B are a perspective view and a sectional view, respectively, illustrating a condensing lens according to an embodiment of the present inventive concept;

FIG. 2 is a diagram illustrating condensing of light emitted in radial directions according to an embodiment of the present inventive concept;

FIGS. 3A and 3B are a perspective view and a sectional view, respectively, illustrating a condensing lens according to another embodiment of the present inventive concept;

FIG. 4 is a diagram illustrating condensing of light emitted in a circumferential direction, according to an embodiment of the present inventive concept;

FIG. 5 is a diagram illustrating light distribution characteristics of the condensing lens shown in FIGS. 3A and 3B;

FIG. 6 is an exploded perspective view illustrating a lighting device according to an embodiment of the present inventive concept.

### DETAILED DESCRIPTION

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification.

Reference will now be made in detail to a condensing lens and a lighting device including the condensing lens according to exemplary embodiments of the present inventive concept.

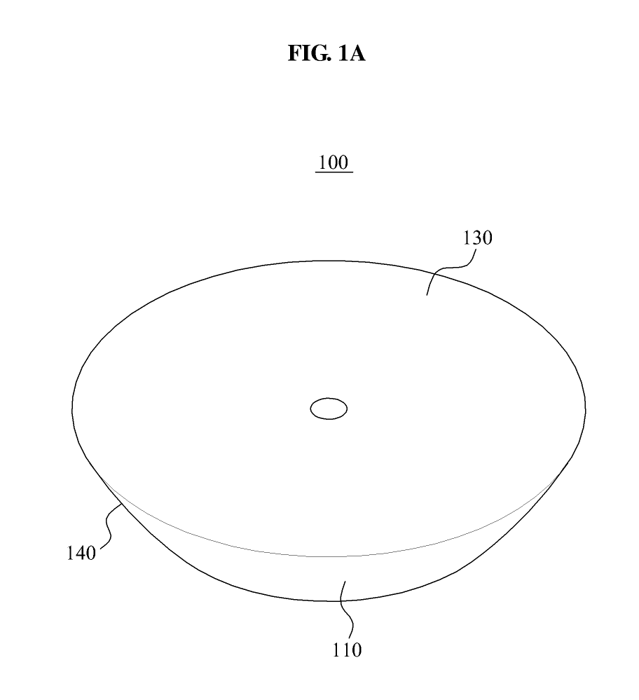

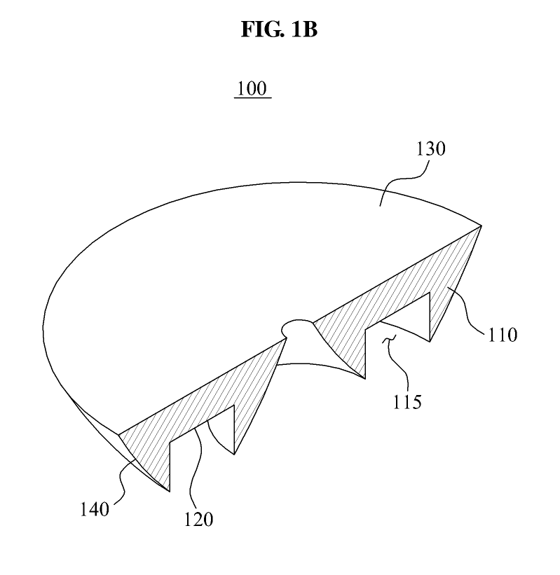

FIGS. 1A and 1B are a perspective view and a sectional view, respectively, illustrating a condensing lens 100 according to an embodiment of the present inventive concept. As shown in FIGS. 1A and 1B, the condensing lens 100 may include a main body 110. Referring to FIG. 1B, the main body 110 may include a light incidence surface 120, a light emission surface 130, and a reflective surface 140.

The main body 110 may include a light emitting diode (LED) receiving portion 115 to receive an LED. In detail, the LED receiving portion 115 may be disposed at one side, for example, a lower surface in an embodiment of the present inventive concept, of the condensing lens 100 including a plane in a circular shape. The LED receiving portion 115 may be depressed, along a circumferential shape having a predetermined radius on the circular plane. The LED receiving portion 115 may have a rectangular cross section. Therefore, the LED receiving portion 115 may substantially have a ring shape. Accordingly, the LED may be disposed along the LED receiving portion 115 depressed in the ring shape. Here, the LED may be received in a chip form or package form. Alternatively, a flat LED or linear LED in a ring shape corresponding to the LED receiving portion 115 may also be used. In addition, width, height, and the like of the LED receiving portion 115 may be determined by size of the LED to be received.

The main body 110 may include the light incidence surface 120, the light emission surface 130, and the reflective surface 140. The light incidence surface 120 will be described first. The light incidence surface 120 may define a boundary between the LED receiving portion 115 and the main body 110. According to the above structure, light emitted from the LED received in the LED receiving portion 115 may be guided into the main body 110 through the light incidence surface 120.

The light emission surface 130 may form another side of the main body 110, for example, an upper surface in an embodiment of the present inventive concept. The light incident to the light incidence surface 120 may be passed through an inside of the main body 110 and emitted to an outside through the light emission surface 130.

The reflective surface 140 may be disposed at a side surface of the main body 110, for example, an inner side surface and an outer side surface of the main body 110.

The reflective surface 140 may reflect the light incident through the light incidence surface 120 and transmit the light to the light emission surface 130. That is, out of the light emitted from the LED received in the LED receiving portion 115, light emitted in radial directions of the condensing lens 100 is reflected by the reflective surface 140 and emitted through the light emission surface 130. Thus, light condensing in radial directions may be achieved.

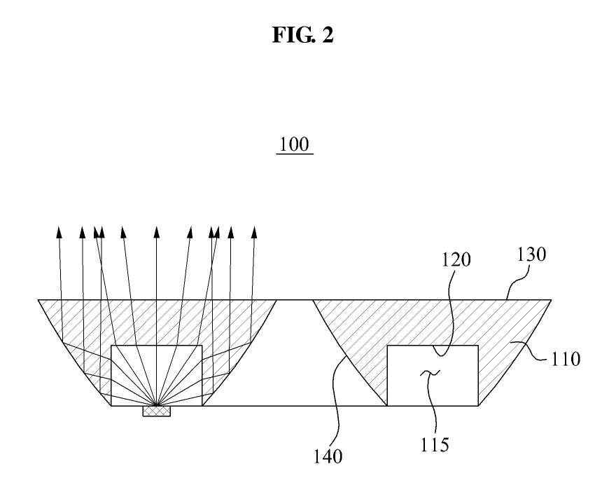

The light condensing will be described with reference to FIG. 2. FIG. 2 is a diagram illustrating condensing of light emitted in radial directions according to an embodiment of the present inventive concept. As shown in FIG. 2, out of the light emitted from the LED, light inclined in radial directions may be reflected by the reflective surface 140. Thus, light condensing in radial directions may be achieved. As shown in FIGS. 1B and 2, the reflective surface 140 may include surfaces inclined in radial directions and may be provided to both the inner surface and the outer surface of the main body 110, symmetrically.

The reflective surface 140 may be designed to totally reflect the light incident through the light incidence surface 120. Total reflection may be achieved by varying an angle of the reflective surface 140, thereby increasing condensing efficiency. The reflective surface 140 may be plated with silver (Ag) or aluminum (Al) to increase efficiency of the total reflection, although the present inventive concept is not limited thereto.

The LED receiving portion 115 may be configured to receive a plurality of LEDs. As aforementioned, the LED receiving portion 115 may be depressed in a ring shape. Accordingly, the plurality of LEDs in the form of a chip or a package may be disposed along the ring shape depression.

According to the aforementioned structure, various types of LED may be applied. For example, a desired light intensity may be obtained using about 4 or 5 high power packages of about 160 lm. Alternatively, about 16 to 20 middle power packages of about 40 lm may replace the expensive high power packages to obtain the equivalent light intensity. In this case, economic efficiency may be considerably increased because the larger number of the middle power packages may cost lower by about 40% than the smaller number of the high power packages in the above example.

In addition, the condensing lens 100 may be configured to entirely cover the plurality of LEDs disposed in the LED receiving portion 115 of the ring shape, rather than being disposed corresponding to each of the LED chips or packages. Therefore, the condensing lens 100 may prevent performance reduction occurring due to overlap between lenses when a plurality of middle power packages are used in a system in which the lenses are provided corresponding to the respective LED chips or packages. Therefore, a desired condensing efficiency may be achieved without performance reduction and with economic advantage.

In an embodiment of the present inventive concept, the condensing lens 100 may be made of a light transmissive resin, for example, polycarbonate, acryl, or polymethylmethacrylate (PMMA). However, the present inventive concept is not limited to those examples.

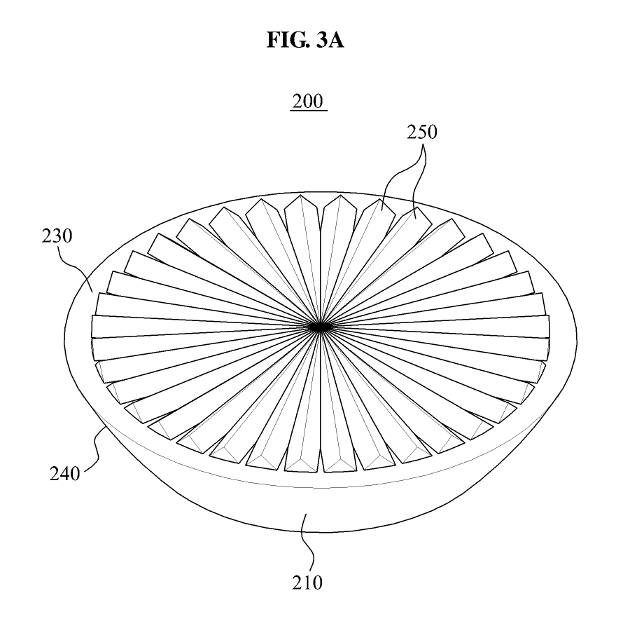

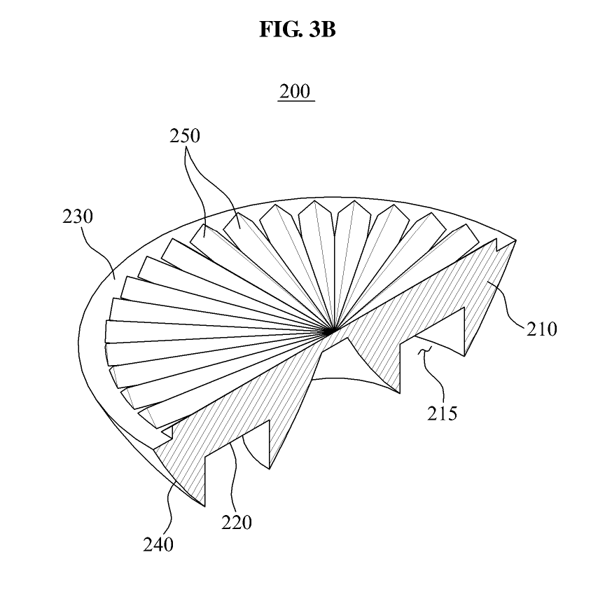

FIGS. 3A and 3B are a perspective view and a sectional view, respectively, illustrating a condensing lens 200 according to another embodiment of the present inventive concept. The condensing lens 200 may include a main body 210. The main body 210 may include a light incidence surface 220, a light emission surface 230, and a reflective surface 240. A plurality of prisms 250 may be provided on the light emission surface 230.

The main body 210 may include an LED receiving portion 215 being depressed to receive an LED. In further detail, the LED receiving portion 215 may be disposed at one side, for example, a lower surface in an embodiment of the present inventive concept, of the condensing lens 200 including a plane in a circular shape. The LED receiving portion 215 may be depressed along a circumferential shape having a predetermined radius on the circular plane. The LED receiving portion 215 may have a rectangular cross section. That is, the LED receiving portion 215 has a substantial ring shape. Accordingly, the LED may be disposed along the LED receiving portion 215 depressed in the ring shape. Here, the LED may be received in a chip form or package form. Alternatively, a flat LED or linear LED in a ring shape corresponding to the LED receiving portion 215 may also be used. In addition, width, height, and the like of the LED receiving portion 215 may be determined by size of the LED to be received.

The main body 210 may include the light incidence surface 220, the light emission surface 230, and the reflective surface 240. The light incidence surface 220 will be described first. The light incidence surface 220 may define a boundary between the LED receiving portion 215 and the main body 210. According to the above structure, light emitted from the LED received in the LED receiving portion 215 may be guided into the main body 210 through the light incidence surface 220.

The light emission surface 230 may form another side of the main body 210, that is, an upper surface of the main body 210 in an embodiment of the present inventive concept. The light incident to the light incidence surface 220 may be passed through an inside of the main body 210 and emitted to the plurality of prisms 250 through the light emission surface 230. The plurality of prisms 250 will be described later. At a part of the light emission surface 230 where the plurality of prisms 250 are absent, the light may be emitted directly to the outside.

As shown in FIGS. 3A and 3B, the reflective surface 240 may be disposed at a side surface, for example an outer side surface, of the main body 210. The reflective surface 240 also may be disposed at an inner side surface of the main body 210 in a manner similar to that illustrated in FIG. 2. The reflective surface 240 may reflect the light incident through the light incidence surface 220 and transmit the light to the light emission surface 230. That is, out of the light emitted from the LED received in the LED receiving portion 215, light emitted in radial directions of the condensing lens 200 is reflected by the reflective surface 240 and emitted to the outside or the plurality of prisms 250 through the light emission surface 230. Accordingly, light condensing in radial directions may be achieved.

Referring back to FIG. 2, the light emitted in radial directions are condensed. Similarly, out of the light emitted from the LED, light inclined in radial directions may be reflected by the reflective surface 240. Thus, light condensing in radial directions may be achieved. Similar to the reflective surface 140 shown in FIG. 2, the reflective surface 240 may include surfaces inclined in radial directions and may be provided to both the inner surface and the outer surface of the main body 210, symmetrically.

Here, the reflective surface 240 may be designed to totally reflect the light incident through the light incidence surface 220. That is, total reflection may be achieved by varying an angle of the reflective surface 240, thereby increasing condensing efficiency. The reflective surface 240 may be plated with Ag or Al to increase efficiency of the total reflection, but the present inventive concept is not limited thereto.

The LED receiving portion 215 may be configured to receive a plurality of LEDs. As aforementioned, the LED receiving portion 215 may be depressed in a circumferential direction in a ring shape. Accordingly, the plurality of LEDs in the form of a chip or a package may be disposed along the ring shape depression.

According to the aforementioned structure, various types of LED may be applied. For example, a desired light intensity may be obtained using about 4 or 5 high power packages of about 160 lm. Alternatively, about 16 to 20 middle power packages of about 40 lm may replace the expensive high power packages to obtain the equivalent light intensity. In this case, economic efficiency may be considerably increased because the larger number of the middle power packages may cost lower by about 40% than the smaller number of the high power packages in the above example.

In addition, the condensing lens 200 may be configured to entirely cover the plurality of LEDs disposed in the LED receiving portion 215 of the ring shape, rather than being disposed corresponding to each of the LED chips or packages. Therefore, the condensing lens 200 may prevent performance reduction occurring due to overlap between lenses when a plurality of middle power packages are used in a system in which the lenses are provided corresponding to the respective LED chips or packages. Therefore, a desired condensing efficiency may be achieved without performance reduction and with economic advantage.

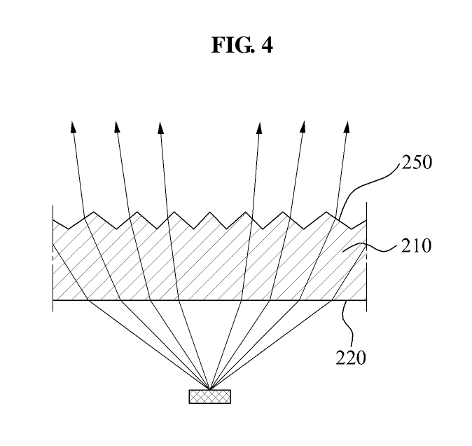

The plurality of prisms 250 may be arranged on the light emission surface 230 of the main body 210 in a circumferential direction. As illustrated in FIGS. 3A and 3B, the plurality of prisms 250 may extend in radial directions while being added at uniform intervals with respect to the circumferential direction for condensing light in the circumferential direction. This will be described with reference to FIG. 4.

FIG. 4 is a diagram illustrating condensing of light emitted in a circumferential direction, according to an embodiment of the present inventive concept. That is, FIG. 4 is a sectional view from the extension direction of the plurality of prisms 250 extending in radial directions from a central axis of the condensing lens 200. As illustrated, light emitted from the LED may be guided to an inside of the main body 210 through the light incidence surface 220, condensed in the radial directions by the reflective surface 240 (see FIG. 3B), and emitted through the light emission surface 230 (see FIG. 3B). The light is not only condensed in the radial directions by the reflective surface but also emitted in the circumferential direction. Therefore, there may be a need of condensing of the light emitted in the circumferential direction. For this purpose, the plurality of prisms 250 may be configured such that the emitted light inclined toward the circumferential direction is refracted toward an optic axis and condensed. Thus, the condensing lens 200 according to an embodiment of the present inventive concept may condense light in both the radial directions and the circumferential direction.

The plurality of prisms 250 may be arranged to be continuous without intervals on the light emission surface 230. The condensing lens 200 may achieve high condensing efficiency even with high power packages. In this case, intervals between packages may be relatively large. Therefore, the plurality of prisms 250, instead of being provided on a part of the light emission surface 230 right above a package, may be arranged from a part of the light emission surface 230 at a predetermined distance in the circumferential direction from each package. Here, the reason is because, considering visibility according to straightness of light, the light emitted to the part of the light emission surface 230 right above the package is not inclined toward the circumferential direction. However, in a middle power package using a plurality of packages, since intervals between the packages are relatively compact, the plurality of prisms 250 may be continuously arranged without intervals to condense the emitted light inclined toward the circumferential direction. According to such arrangement, a desired light condensing efficiency may be achieved even when a plurality of LEDs are received in the LED receiving portion 215. Consequently, light distribution characteristics may be improved.

When the plurality of LEDs are received in the LED receiving portion 215, a length of a lower surface of each of the prisms 250 continuously arranged may be smaller than an interval between the plurality of LEDs. With such configuration, when the LEDs emit light, the LEDs, instead of being recognized separately by naked eyes, may be recognized, by naked eyes, to emit light as a whole. Therefore, light distribution characteristics with higher softness and brightness may be obtained. Conversely, when the length of the lower surface of each prism 250 is greater than the interval between the plurality of LEDs, the LEDs may be recognized by naked eyes. Therefore, light distribution characteristics with relatively lower brightness may be obtained.

The condensing lens 200 according to an embodiment of the present inventive concept may be made of a light transmissive resin, for example, polycarbonate, acryl, or polymethylmethacrylate (PMMA). However, the present inventive concept is not limited to those examples.

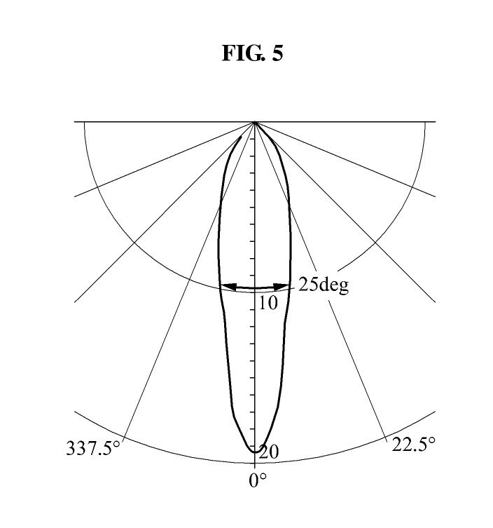

FIG. 5 is a diagram illustrating light distribution characteristics of the condensing lens 200 of FIGS. 3A and 3B. The condensing lens 200 may be capable of light condensing in both of radial directions by the portion 240 and the circumferential direction by the prisms 250. As shown in FIG. 5, a beamwidth corresponding to about half a maximum light intensity is 25 degree. That is, light distribution characteristics are excellent. Thus, the condensing lens 200 may achieve excellent light distribution characteristics and, simultaneously, have economical advantage by using a plurality of middle power packages, which are relatively inexpensive, without performance reduction.

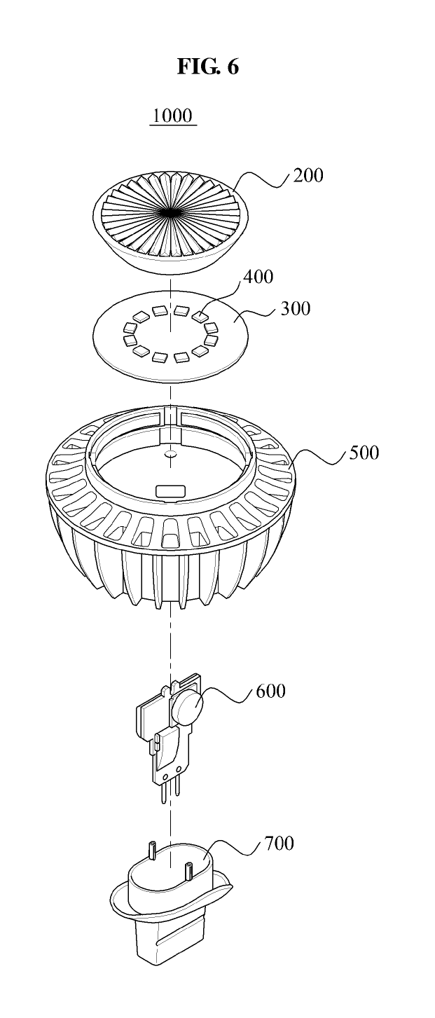

FIG. 6 is an exploded perspective view illustrating a lighting device 1000 according to an embodiment of the present inventive concept. As illustrated, the lighting device 1000 may include a substrate 300, an LED 400, the condensing lens 200, a heat sink 500, and a power device 600.

The LED 400 may be in the form of a chip or package. Alternatively, the LED 400 may be a linear LED or a flat LED in a ring shape corresponding to a shape of the aforementioned LED receiving portion 115 or 215.

The LED 400 may be mounted to one surface of the substrate 300. The substrate 300 may be a printed circuit board (PCB) but is not limited thereto.

A circuit wiring electrically connected with the LED 400 may be provided to a surface of the substrate 300 opposite to the surface with the LED 400 mounted thereto. Between the opposite surface of the substrate 300 and the heat sink 500, a thermal interface material such as a heat radiation pad, a phase change material, or a heat radiation tape may be applied to minimize thermal resistance.

The heat sink 500 may be configured to receive and support the substrate 300 to which the LED 400 is mounted. In addition, the heat sink 500 may radiate heat generated from the LED 400 to the outside.

The heat sink 500 may include a plurality of heat radiation fins or heat radiation plates radially arranged along a circumference. The heat radiation fins or heat radiation plates may be made of a material selected from thermal conductive materials including copper (Cu), Ag, Al, iron (Fe), nickel (Ni), tungsten (W), and ceramic. That is, by including the material having high thermal conductivity, the heat sink 500 may further increase heat radiation efficiency of the lighting device 1000.

The power device 600 may provide power to the LED 400. The power device 600 may include a control circuit that provides power to the LED 400. Position and configuration of the power device 600 may be varied according to a type and a design purpose of the lighting device 1000. In addition, the power device 600 may be made of polybutylacrylate (PBA).

The lighting device 1000 may further include a housing 700. The housing 700 may surround and protect the power device 600. An inside and an outside of the housing 700 may be coated with an insulating material so that the housing 700 is insulated from electronic elements of the control circuit of the power device 600. The housing 700 may be made of polybuthyleneterephthalate (PBT).

The condensing lens 200 according to an embodiment of the present inventive concept may be used as the condensing lens. Therefore, a description about the condensing lens 200 will be omitted.

The LED 400 may be plural in number.

Although a few exemplary embodiments of the present inventive concept have been shown and described, the present inventive concept is not limited to the described exemplary embodiments. Instead, it would be appreciated by those skilled in the art that changes may be made to these exemplary embodiments without departing from the principles and spirit of the invention, the scope of which is defined by the appended claims and their equivalents.

What is claimed is:

1. A condensing lens, comprising:
a main body including a light emitting diode (LED) receiving portion defined in a ring shape and depressed at one side of the main body to receive an LED in a circumferential direction,
wherein the main body comprises a light incidence surface to which light emitted from the LED is incident, a light emission surface defined at another side of the main body and configured to emit the incident light, and a reflective surface to reflect the incident light.

2. The condensing lens of claim 1, wherein the LED receiving portion is configured to receive a plurality of LEDs.

3. The condensing lens of claim 1, wherein the reflective surface is configured to perform total reflection.

4. The condensing lens of claim 1, further comprising a plurality of prisms arranged in a circumferential direction on the light emission surface.

5. The condensing lens of claim 4, wherein the plurality of prisms are arranged continuously without intervals.

6. The condensing lens of claim 5, wherein:
the LED receiving portion is configured to receive a plurality of LEDs, and
a length of a lower surface of each of the plurality of prisms is smaller than an interval between the plurality of LEDs when the plurality of LEDs are received in the LED receiving portion.

7. A lighting device, comprising:
a substrate;
a light emitting diode (LED) disposed on the substrate;
a condensing lens configured to condense light emitted from the LED;
a heat sink configured to receive and support the substrate and to emit heat generated from the LED to an outside; and
a power device configured to provide power to the LED, wherein:
the condensing lens includes: a main body including a light emitting diode (LED) receiving portion defined in a ring shape and depressed at one side of the main body to receive the LED in a circumferential direction, and
the main body comprises a light incidence surface to which light emitted from the LED is incident, a light emission surface defined at another side of the main body and configured to emit the incident light, and a reflective surface to reflect the incident light.

8. The lighting device of claim 7, wherein the LED is a plurality of LEDs.

9. The lighting device of claim 7, wherein the LED is a linear LED or a flat LED in a ring shape corresponding to the ring shape of the LED receiving portion.

10. The lighting device of claim 7, wherein a thermal interface material is applied between a surface of the substrate and the heat sink to minimize thermal resistance.

11. The lighting device of claim 7, wherein the heat sink includes a plurality of heat radiation fins or heat radiation plates radially arranged along a circumference.

12. A condensing lens, comprising:
a main body including a light emitting diode (LED) receiving portion defined in a ring shape and depressed at one side of the main body to receive an LED in a circumferential direction,
wherein the main body has a reflective surface defined at an inner surface and an outer surface of the main body such that light emitted from the LED is reflected and condensed in a radial direction when the LED is received in the LED receiving portion.

13. The condensing lens of claim 12, wherein:
the main body comprises a light incidence surface to which the light emitted from the LED is incident and a light emission surface defined at another side of the main body and configured to emit the incident light, and
the reflective surface is configured to reflect the incident light.

14. The condensing lens of claim 12, wherein the reflective surface includes surfaces inclined in radial directions.

15. The condensing lens of claim 12, wherein the reflective surface include a first surface disposed on the inner surface and a second surface disposed on the outer surface of the main body, the first and second surfaces being symmetrically disposed.

16. The condensing lens of claim 12, wherein the LED receiving portion has a rectangular cross section.

17. The condensing lens of claim 13, wherein the light emission surface is defined by a plurality of prisms, each of which extends concentrically to the center of the light emission surface.
